(19) United States
(12) Patent Application Publication
(10) Pub. No.: US 2009/0049663 A1
(43) Pub. Date: Feb. 26, 2009

(54) WEIGHT-HANGING HOOK

(76) Inventor: Rong-Der HONG, Taichung (TW)

Correspondence Address: FOLEY AND LARDNER LLP;SUITE 500, 3000 K STREET NW, WASHINGTON, DC, 20007, US

(21) Appl. No.: 11/942,310

(22) Filed: Nov. 19, 2007

(30) Foreign Application Priority Data
Aug. 23, 2007 (TW) 096214038

(51) Int. Cl. F16B 45/02

(52) U.S. Cl. 24/600.1

(57) ABSTRACT

A weight-hanging hook includes a hook body, a pivotable safety retainer biased to a close position to close an opening in the hook body, a locking member disposed movably within a slot in the hook body and movable between a first position whereat the locking member engages the safety retainer so as to lock the safety retainer in the close position, and a second position whereat the locking member is removed from the safety retainer. An operating member is disposed pivotally on the hook body, and is biased to a non-driving position whereat the locking member is disposed in the first position. The operating member is operable to move the locking member to the second position so as to allow the safety retainer to be operated to separate from the hook portion, thereby opening the opening in the hook body.

### CROSS-REFERENCE TO RELATED APPLICATION

This application claims priority of Taiwanese Application No. 096214038, filed on Aug. 23, 2007.

### BACKGROUND OF THE INVENTION

1. Field of the Invention

This invention relates to a hanging hook, and more particularly to a weight-hanging hook.

2. Description of the Related Art

Referring to FIGS. 1 and 2, a conventional weight-hanging hook 1 includes a hook body 11, a safety retainer 12, and a locking member 13. The hook body 11 has a hook portion 112 disposed at an end thereof and defining an opening 111. The safety retainer 12 is disposed pivotally on the hook body 11, and is biased to close the opening 111. The locking member 13 is formed with two lugs 131 biased to press against the safety retainer 12 to thereby prevent unintentional removal of the safety retainer 12 from the hook portion 112.

When the operating member 13 is operated to pivot from a normal position shown by the solid lines in FIG. 2 to a release position shown by the phantom lines in FIG. 2, the safety retainer 12 is released from the lugs 131 of the operating member 13, thereby allowing the safety retainer 12 to be pivoted through user manipulation, from a close position shown by the solid lines in FIG. 2 to an open position shown by the phantom lines in FIG. 2. The aforesaid conventional weight-hanging hook 1 has a drawback. That is, since the lugs 131 are in the form of plates, the contact area between the lugs 131 and the safety retainer 12 is limited. As a result, the lugs 131 deform easily after a long period of use. When deformation of the lugs 131 occurs, the safety retainer 12 cannot be locked effectively on the hook portion 112 of the hook body 11. This poses safety risks during use.

### SUMMARY OF THE INVENTION

The object of this invention is to provide a weight-hanging hook that has enhanced safety features.

According to this invention, a weight-hanging hook comprises:

a hook body having a slot formed therethrough, and a hook portion disposed at an end thereof and defining an opening;

a retaining unit including a safety retainer connected pivotally to the hook body, and a first resilient member for biasing the safety retainer to a close position so as to close the opening in the hook body; and

a locking unit including
a locking member disposed movably within the slot in the hook body and movable within the slot between a first position whereat the locking member engages the safety retainer so as to lock the safety retainer in the close position, and a second position whereat the locking member is removed from the safety retainer so as to allow the safety retainer to be operated to separate from the hook portion, thereby opening the opening in the hook body, the locking member being configured as a rod,
an operating member disposed pivotally on the hook body and connected to the locking member, and
a second resilient member for biasing the operating member to a non-driving position whereat the locking member is disposed in the first position, the operating member being operable against the biasing action of the second resilient member to move to a driving position whereat the locking member is moved to the second position.

Since the locking member is a rod, and is disposed movably within the slot in the hook body, it has a high structural strength, which can prevent deformation thereof after a long period use.

### BRIEF DESCRIPTION OF THE DRAWINGS

These and other features and advantages of this invention will become apparent in the following detailed description of the preferred embodiments of this invention, with reference to the accompanying drawings, in which:

FIG. 1 is a front view of a conventional weight-hanging hook;

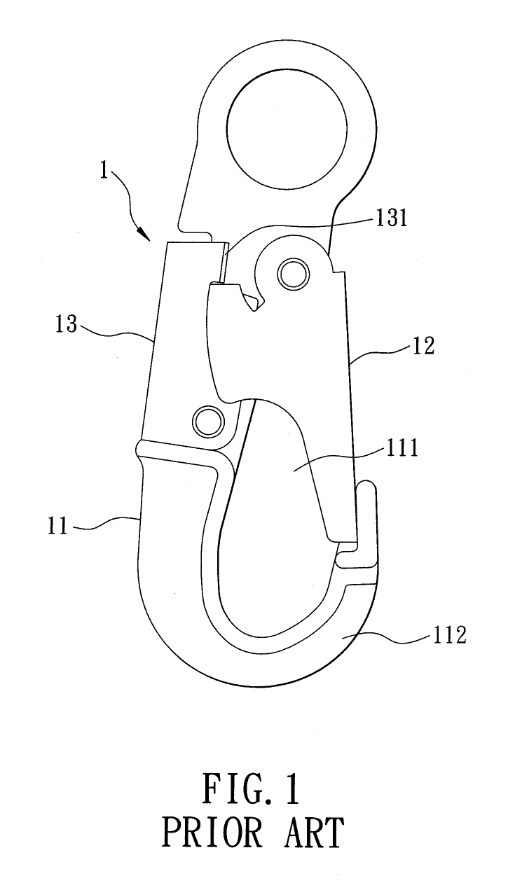

FIG. 2 is a view similar to FIG. 1 but illustrating how a safety retainer is pivoted from a close position to an open position;

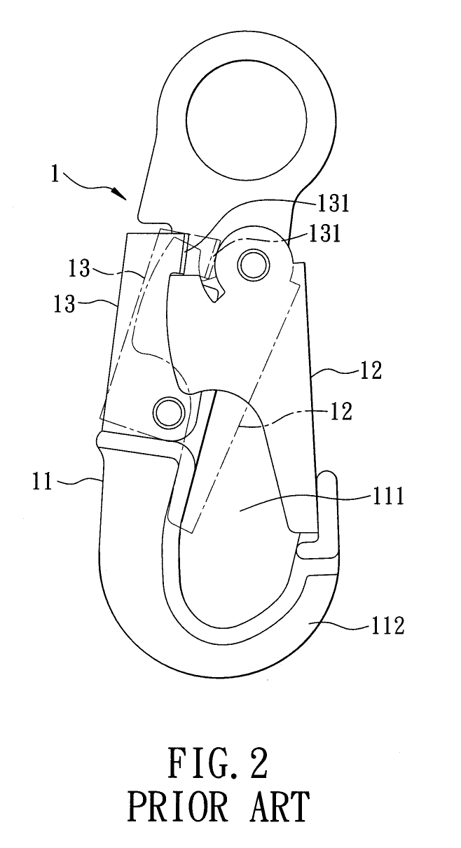

FIG. 3 is an exploded perspective view of the first preferred embodiment of a weight-hanging hook according to this invention;

FIG. 4 is an assembled perspective view of the first preferred embodiment;

FIG. 4A is a front view of the first preferred embodiment, illustrating a non-driving position of an operating member and a close position of a safety retainer;

FIG. 5 is a view similar to FIG. 4A but illustrating a driving position of the operating member and the close position of the safety retainer;

FIG. 6 is a view similar to FIG. 4A but illustrating the driving position of the operating member and an open position of the safety retainer;

FIG. 7 is an exploded perspective view of the second preferred embodiment of a weight-hanging hook according to this invention;

FIG. 8 is a front view of the second preferred embodiment, illustrating a non-driving position of an operating member and a close position of a safety retainer;

FIG. 9 is a view similar to FIG. 8 but illustrating a driving position of the operating member and the close position of the safety retainer;

FIG. 10 is a view similar to FIG. 8 but illustrating the driving position of the operating member and an open position of the safety retainer;

FIG. 11 is an exploded perspective view of the third preferred embodiment of a weight-hanging hook according to this invention;

FIG. 12 is a front view of the third preferred embodiment, illustrating a non-driving position of an operating member and a close position of a safety retainer;

FIG. 13 is a view similar to FIG. 12 but illustrating a driving position of the operating member and the close position of the safety retainer; and

FIG. 14 is a view similar to FIG. 12 but illustrating the driving position of the operating member and an open position of the safety retainer.

### DETAILED DESCRIPTION OF THE PREFERRED EMBODIMENTS

Before the present invention is described in greater detail in connection with the preferred embodiments, it should be noted that similar elements and structures are designated by like reference numerals throughout the entire disclosure.

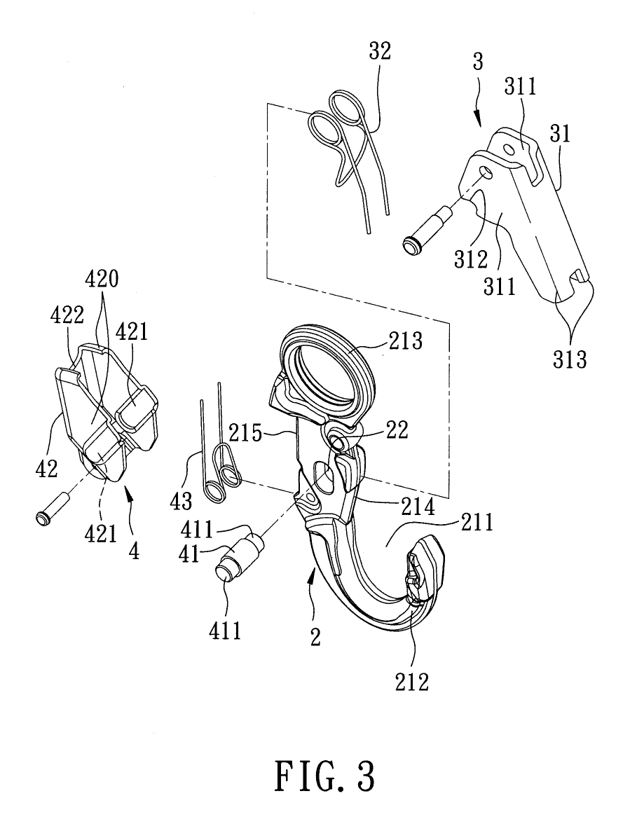

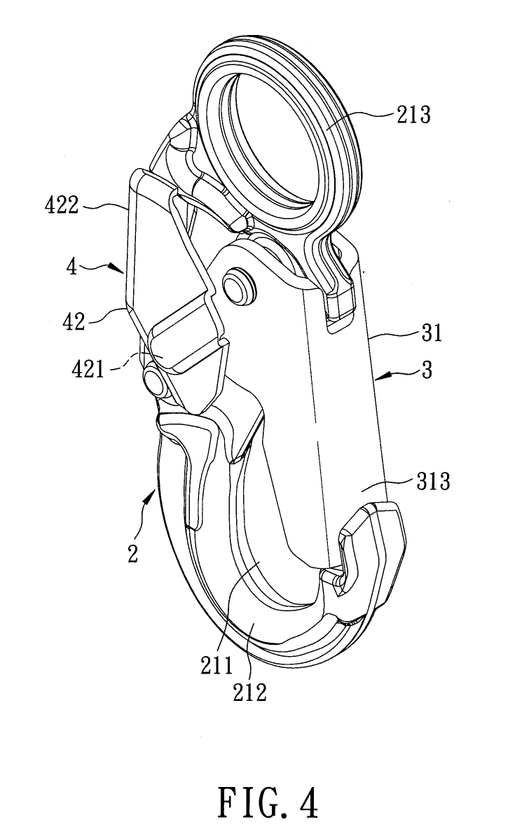

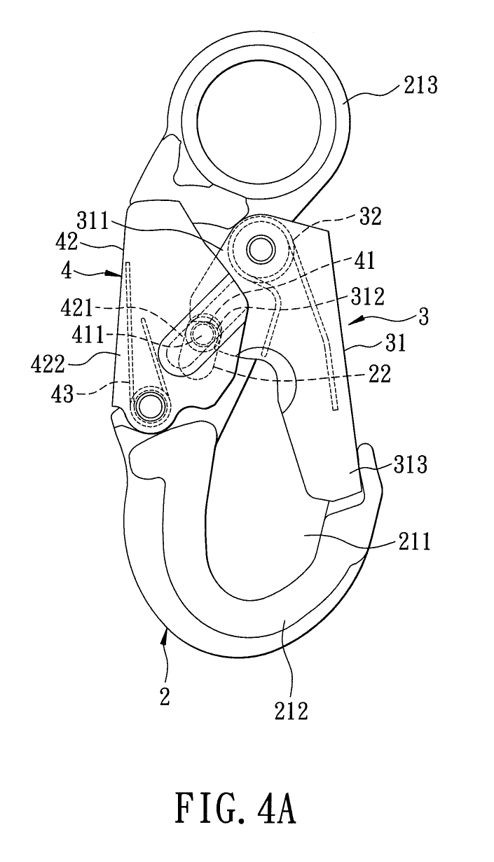

Referring to FIGS. 3, 4, and 4A, the first preferred embodiment of a weight-hanging hook according to this invention includes a hook body 2, a retaining unit 3, and a locking unit 4.

The hook body 2 has a hook portion 212 disposed at an end thereof and defining an opening 211, a ring portion 213 disposed at an opposite end thereof, an inner side surface 214 proximate to the hook portion 212, an outer side surface 215 distal from the hook portion 212, and a slot 22 formed therethrough the hook body 2 and disposed between the first and second side surfaces 214, 215.

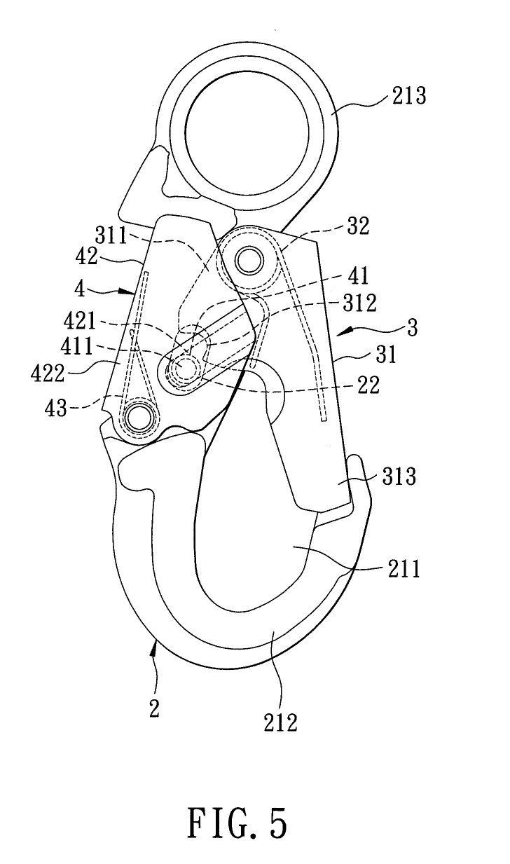

The retaining unit 3 includes a safety retainer 31 and a first resilient member 32. The safety retainer 31 includes two interconnected retaining plates 311 each connected pivotally to the hook body 2 and formed with a curved engaging edge 312 at an end thereof and a retaining portion 313 at an opposite end thereof. The first resilient member 32 is disposed between the safety retainer 31 and the hook body 2 for biasing the safety retainer 31 to a close position shown in FIG. 5. In the close position, the retaining portions 313 are in contact with the hook portion 212 to close the opening 211.

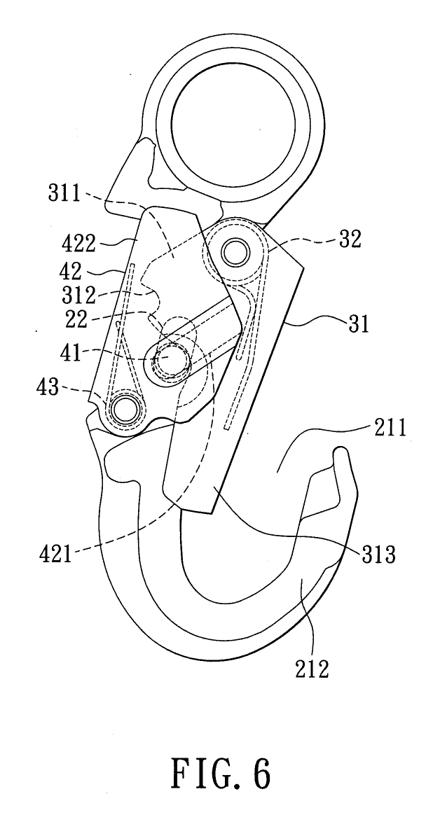

The locking unit 4 includes a locking member 41 configured as a rod, an operating member 42, and a second resilient member 43. The locking member 41 is disposed movably within the slot 22 in the hook body 2 such that two opposite ends of the locking member 41 extend outwardly of the slot 22. The locking member 41 is movable within the slot 22 between a first position shown in FIG. 4A and a second position shown in FIG. 5. In the first position, the locking member 41 is in contact with the curved engaging edges 312 of the safety retainer 32 so as to lock the safety retainer 31 in the close position. In the second position, the locking member 41 is removed from the curved engaging edges 312 so as to allow the safety retainer 31 to be operated to separate from the hook portion 212, thereby opening the opening 211 in the hook body 2, as shown in FIG. 6. The operating member 42 is disposed pivotally on the hook body 2, and has two parallel side plates 420 formed respectively with two aligned curved pushing edges 421, and an operating plate 422 interconnecting integrally the side plates 420. The second resilient member 43 is configured as a torsion spring, is disposed between the operating plate 422 and the hook body 2, and presses against and biases the operating plate 422 to pivot away from the slot 22 in the hook body 2. As such, the operating member 42 is biased to a non-driving position shown in FIG. 4A whereat the locking member 41 is disposed in the first position.

The operating member 42 can be pressed against the biasing action of the second resilient member 43 to pivot from the non-driving position shown in FIG. 4A to the driving position shown in FIG. 5. Hence, the curved pushing edges 421 of the operating member 42 come into contact with two opposite ends of the locking member 41, respectively, to thereby move the locking member 41 to the second position. In this state, the safety retainer 31 can be operated and pivoted to separate from the hook portion 212 of the hook body 2 against the biasing action of the first resilient member 32.

When the safety retainer 31 and the operating member 42 are released, they are biased respectively by the first and second resilient members 32, 43 to return to their original positions shown in FIG. 4A.

Since the locking member 41 is a rod, and is disposed movably within the slot 22 in the hook body 2, it has a high structural strength, which can prevent deformation thereof after a long period use.

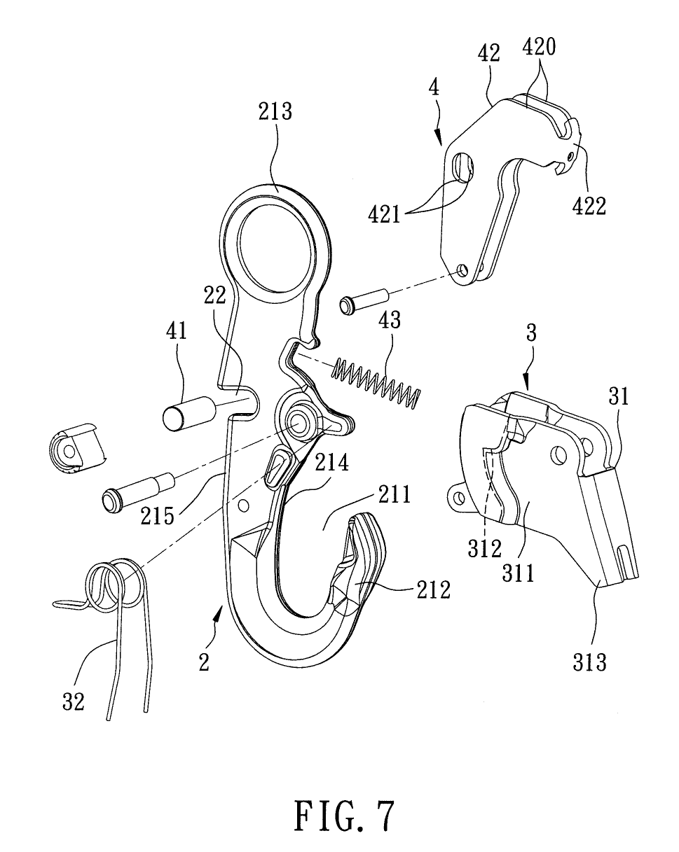

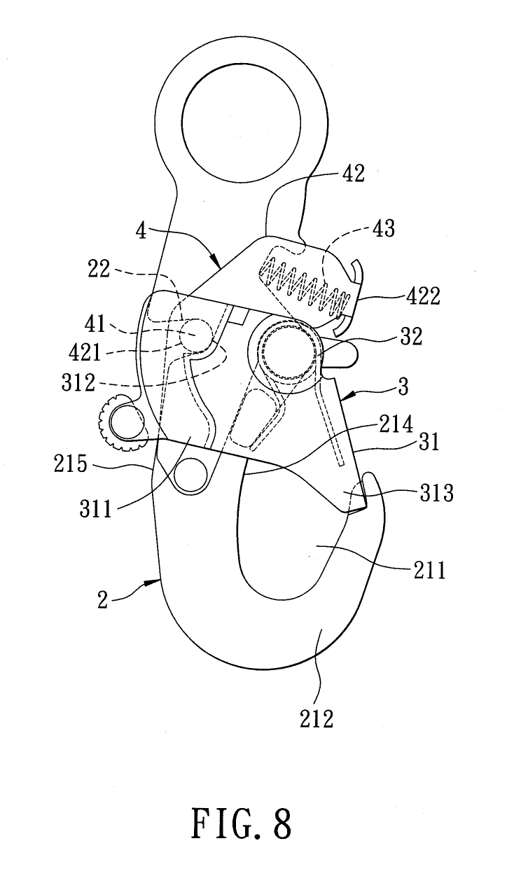

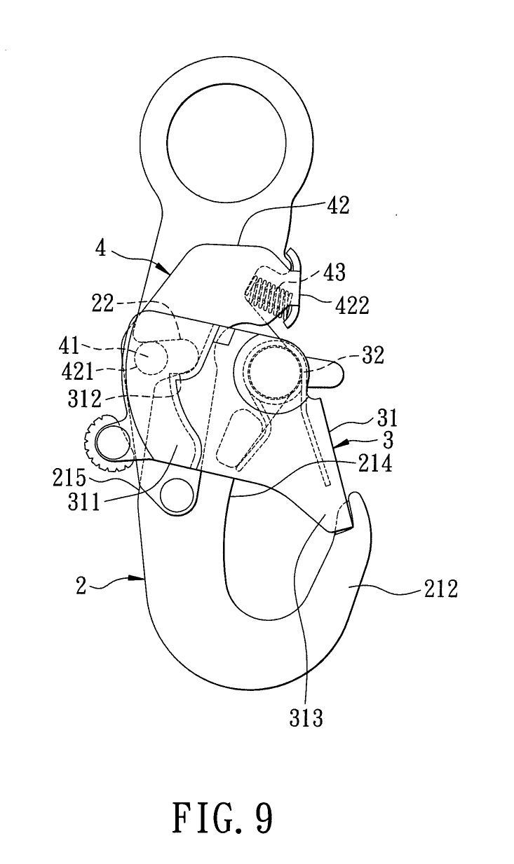

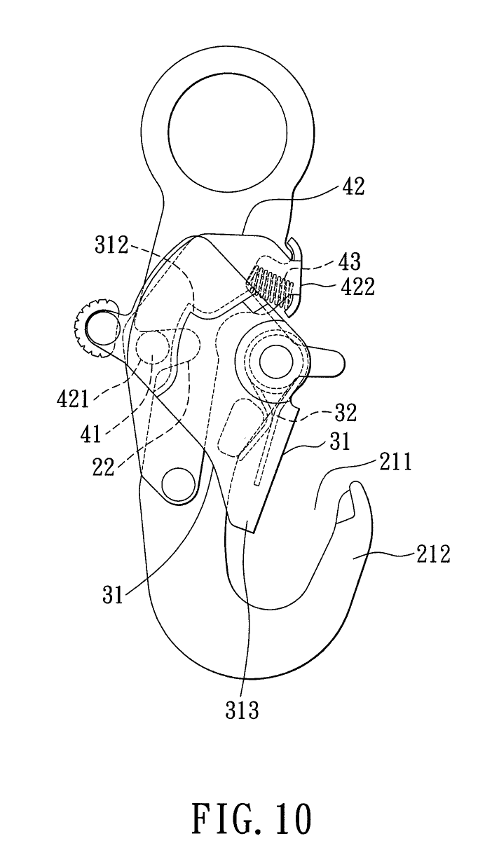

FIGS. 7, 8, 9, and 10 show the second preferred embodiment of a weight-hanging hook according to this invention, which is similar in construction to the first preferred embodiment except for structures described below.

The slot 22 is formed in the outer side surface 215.

The safety retainer 31 includes two retaining plates 311 formed integrally with each other and generally parallel to each other, and a curved engaging edge 312 disposed between the retaining plates 311.

The locking member 41 is disposed between the retaining plates 311. When in the first position, the locking member 41 is in contact with the curved engaging edge 312 at a middle portion thereof so as to prevent pivoting movement of the safety retainer 31 relative to the hook body 2. When in the second position, the locking member 41 is removed from the curved engaging edge 312 so as to allow for pivoting movement of the safety retainer 31 relative to the hook body 2.

The operating member 42 has two parallel side plates 420 formed respectively with two aligned circular holes 421. The locking member 41 has two opposite end portions received respectively and fittingly within the circular holes 421. The operating member 42 further has an operating plate 422 interconnecting integrally the side plates 420. The second resilient member 43 is configured as a coiled compression spring, and is disposed between the hook body 2 and the operating plate 422 for biasing the operating plate 422 to pivot away from the slot 22 in the hook body 2.

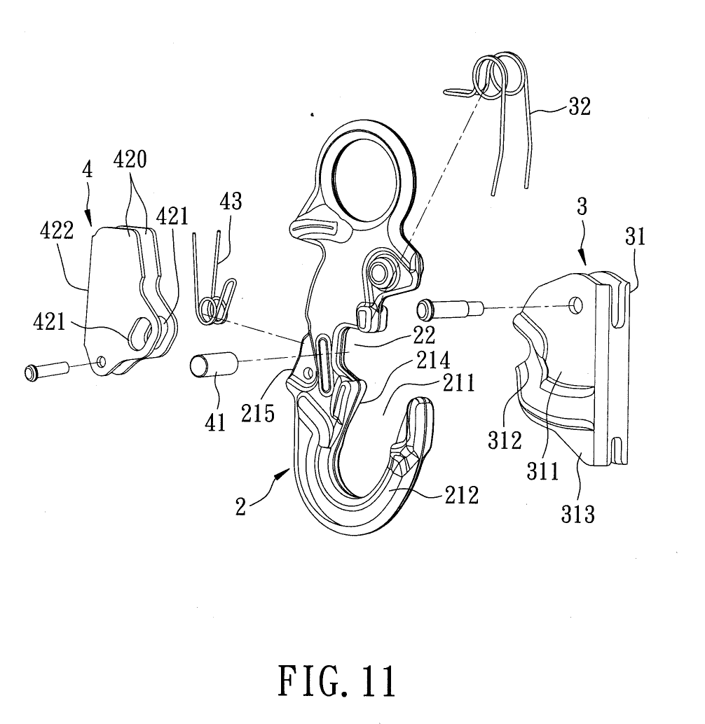

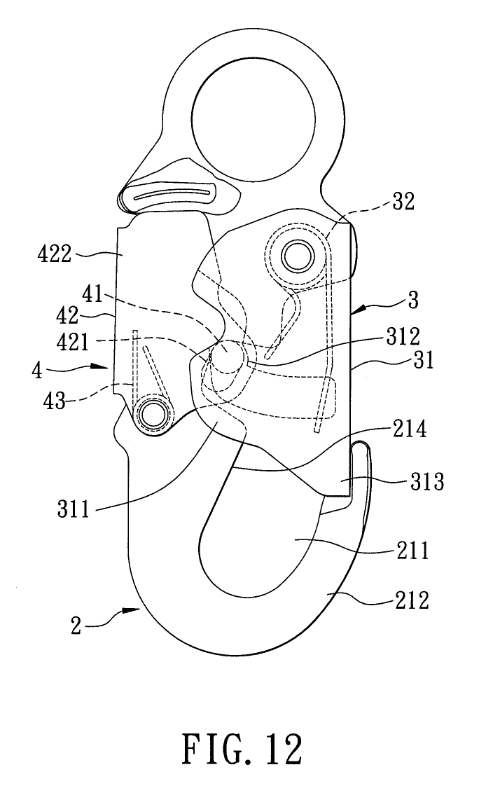

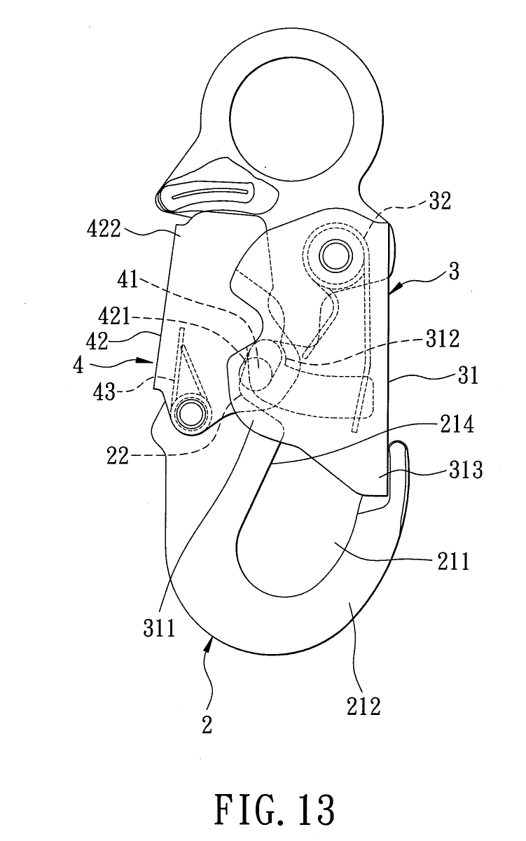

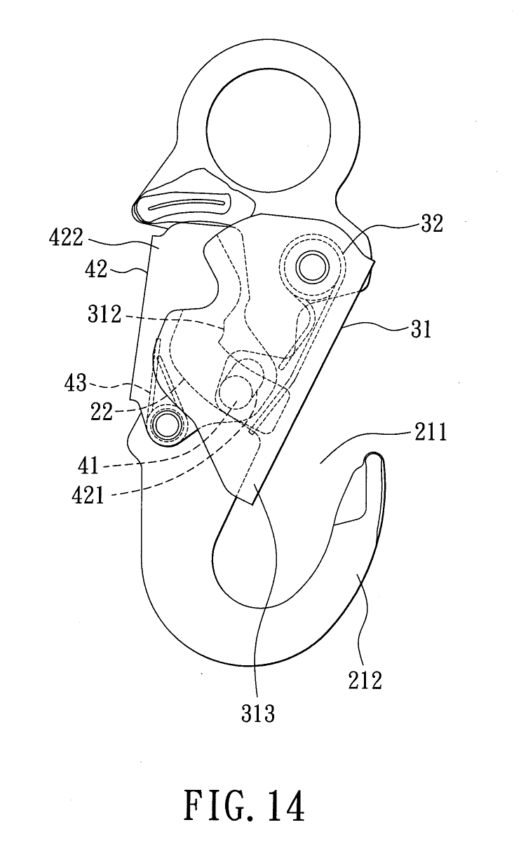

FIGS. 11, 12, 13, and 14 show the third preferred embodiment of a weight-hanging hook according to this invention, which is similar in construction to the first preferred embodiment except for structures described below.

The slot 22 is formed in the inner side surface 214 of the hook body 2.

The operating member 42 has two parallel side plates 420 formed respectively with two aligned circular holes 421 formed therethrough. The locking member 41 has two opposite end portions received respectively and fittingly within the circular holes 421 in the operating member 42.

With this invention thus explained, it is apparent that numerous modifications and variations can be made without departing from the scope and spirit of this invention. It is therefore intended that this invention be limited only as indicated by the appended claims.

I claim:

1. A weight-hanging hook comprising:
a hook body having a slot formed therethrough, and a hook portion disposed at an end thereof and defining an opening;
a retaining unit including a safety retainer connected pivotally to said hook body, and a first resilient member for biasing said safety retainer to a close position so as to close said opening in said hook body; and
a locking unit including
a locking member disposed movably within said slot in said hook body and movable within said slot between a first position whereat said locking member engages said safety retainer so as to lock said safety retainer in said close position, and a second position whereat said locking member is removed from said safety retainer so as to allow said safety retainer to be operated to separate from said hook portion, thereby opening said opening in said hook body, said locking member being configured as a rod,
an operating member disposed pivotally on said hook body and connected to said locking member, and
a second resilient member for biasing said operating member to a non-driving position whereat said locking member is disposed in said first position, said operating member being operable against the biasing action of said second resilient member to move to a driving position whereat said locking member is moved to said second position.

2. The weight-hanging hook as claimed in claim 1, wherein said hook body has opposite inner and outer side surfaces, said inner side surface being proximate to said hook portion, said outer side surface being distal from said hook portion, said slot being disposed between said inner and outer side surfaces.

3. The weight-hanging hook as claimed in claim 2, wherein:
said safety retainer of said retaining unit includes two interconnected retaining plates each formed with a curved engaging edge; and
said locking member is in contact with said curved engaging edges so as to prevent pivoting movement of said safety retainer relative to said hook body when in said first position, and is removed from said curved engaging edges so as to allow for pivoting movement of said safety retainer relative to said hook body when in said second position.

4. The weight-hanging hook as claimed in claim 3, wherein said operating member has two parallel side plates formed respectively with two aligned curved pushing edges movable to contact two opposite ends of said locking member to thereby move said locking member from said first position to said second position when said operating member is operated to move from said non-driving position to said driving position.

5. The weight-hanging hook as claimed in claim 4, wherein said operating member further has an operating plate interconnecting integrally said side plates, said second resilient member being configured as a torsion spring, and pressing against and biasing said operating plate to pivot away from said slot in said hook body.

6. The weight-hanging hook as claimed in claim 1, wherein said hook body has opposite inner and outer side surfaces, said inner side surface being proximate to said hook portion, said outer side surface being distal from said hook portion, said slot being formed in said outer side surface of said hook body.

7. The weight-hanging hook as claimed in claim 6, wherein:
said safety retainer of said retaining unit includes two retaining plates formed integrally with each other and generally parallel to each other, and a curved engaging edge disposed between said retaining plates; and
said locking member is disposed between said retaining plates of said safety retainer, and has a middle portion that is in contact with said curved engaging edge of said safety retainer so as to prevent pivoting movement of said safety retainer relative to said hook body when in said first position, and that is removed from said curved engaging edge so as to allow for pivoting movement of said safety retainer relative to said hook body when in said second position.

8. The weight-hanging hook as claimed in claim 7, wherein
said operating member has two parallel side plates formed respectively with two aligned circular holes; and
said locking member has two opposite end portions received respectively and fittingly within said holes in said operating member such that pivoting movement of said operating member from said non-driving position to said driving position results in movement of said locking member from said first position to said second position.

9. The weight-hanging hook as claimed in claim 8, wherein said operating member further has an operating plate interconnecting integrally said side plates, and said second resilient member is configured as a coiled compression spring, and is disposed between said operating plate and said hook body for biasing said operating plate to pivot away from said slot in said hook body.

10. The weight-hanging hook as claimed in claim 1, wherein said hook body has opposite inner and outer side surfaces, said inner side surface being proximate to said hook portion, said outer side surface being distal from said hook portion, said slot being formed in said inner side surface of said hook body.

11. The weight-hanging hook as claimed in claim 10, wherein:
said safety retainer of said retaining unit includes two interconnected retaining plates each formed with a curved engaging edge; and
said locking member is in contact with said curved engaging edges so as to prevent pivoting movement of said safety retainer relative to said hook body when in said first position, and is removed from said curved engaging edges so as to allow for pivoting movement of said safety retainer relative to said hook body when in said second position.

12. The weight-hanging hook as claimed in claim 11, wherein:
said operating member has two parallel side plates formed respectively with two aligned circular holes formed therethrough; and
said locking member has two opposite end portions received respectively and fittingly within said circular holes in said operating member such that pivoting movement of said operating member from said non-driving position to said driving position results in movement of said locking member from said first position to said second position.

13. The weight-hanging hook as claimed in claim 12, wherein said operating member further has an operating plate interconnecting integrally said side plates, said second resilient member being configured as a torsion spring, and pressing against and biasing said operating plate to pivot away from said slot in said hook body.
